(19) United States
(12) Patent Application Publication
(10) Pub. No.: US 2009/0251325 A1
(43) Pub. Date: Oct. 8, 2009

(54) S.S. carbon monoxide detector

(76) Inventors: George Edwards Smith, Columbus, OH (US); William L. Saunders, Columbus, OH (US)

Correspondence Address: George E. Smith, P.O. Box 1432, Westerville, OH, 43086, US

(21) Appl. No.: 12/080,762

(22) Filed: Apr. 4, 2008

(51) Int. Cl. G08B 21/14

(52) U.S. Cl. 340/632

(57) ABSTRACT

The S S Carbon Monoxide Detector is a carbon monoxide sensor unit for garages, a rectangular shaped unit varied in size according to garage door applications, that detects the presence of dangerous levels of carbon monoxide concentrated in a garage area. On the front of the unit is the audio speaker that sounds alarm, carbon monoxide sensor, unit operation light that indicates unit is operational, and a standard outlet. On the rear of unit is a standard electrical plug which plugs into any standard electrical outlet. The unit operates from standard electricity when plugged into an outlet near the garage door opener, garage door opener is then plugged into the sensor unit which causes the sensor unit to be operational and power the garage door opener to respond to the carbon monoxide sensor once dangerous levels of carbon monoxide is detected by unit.

### BACKGROUND OR PROBLEM

Many home garages can be dangerous as a running vehicle parked inside can emit carbon monoxide, which can quickly poison any living animal inside garage. Without a safe way to detect the toxic gas, an enclosed garage can remain dangerous until the garage door is lifted to air out the space. S S Carbon Monoxide Detector will alert when this poison is detected and will also lift an automatic garage door to prevent overexposure to the chemical gas. This simple detection system will prevent poisonings that commonly occur in enclosed garage space.

### Solution

S. S. Carbon Monoxide Detector is a specially designed carbon monoxide detection unit made for placement in a garage to ensure the safety of garage users. This innovative product will work in conjunction with an automatic garage door to lift the door upon the detection of carbon monoxide. Should a garage become filled with the toxic fumes of carbon monoxide, the S. S. Carbon Monoxide Detector will automatically alert those inside and lift the garage door to prevent prolonged exposure that can result in death. This product will eliminate accidents that can occur due to carbon monoxide poisoning.

### DETAILED DESCRIPTION OF INVENTION

S.S. Carbon Monoxide Detector is a carbon monoxide detection unit that is made for use inside a home garage. The detection system can be plugged into any standard wall outlet or into the receptacle or motor area of an automatic garage door sensor unit for use. S. S. Carbon Monoxide Detector notes the convenience of receptacle capabilities itself, allowing other electrical components to plugged into the front face of the unit. A sensor on the face designed to pick up the presence of carbon monoxide will, upon detection, initiate an audible alert while simultaneously lifting the automatic garage door. This smart design functions by way of a predetermined means and can be made in sizes and designs to suit a variety of garages.

### DETAILED DESCRIPTIONS OF DRAWINGS ATTACHED

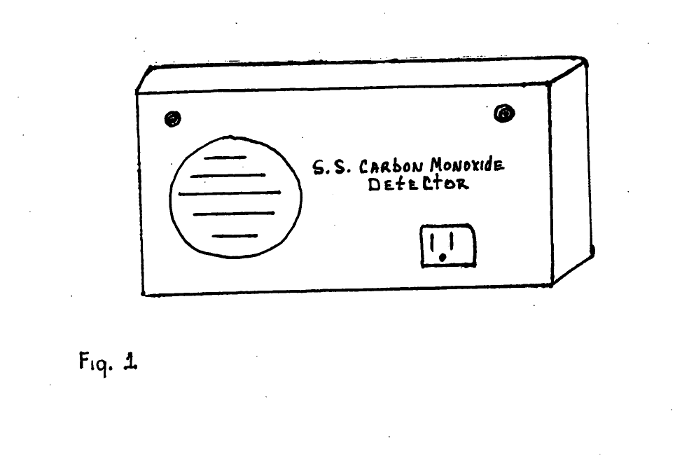

FIG. 1 shows S.S. Carbon Monoxide Detector 3-D full frontal view.

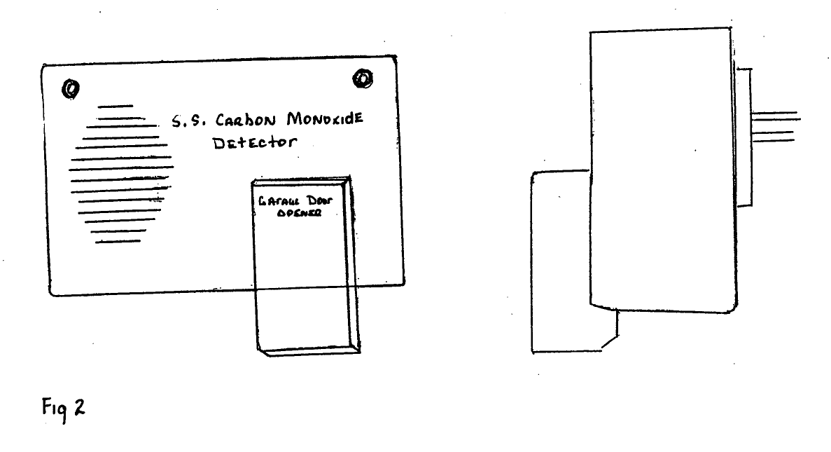

FIG. 2A shows a frontal view attached to a wall with garage door opener plugged into unit. FIG. 2B shows unit from a side view plugged into electrical outlet with garage door opener plugged into unit.

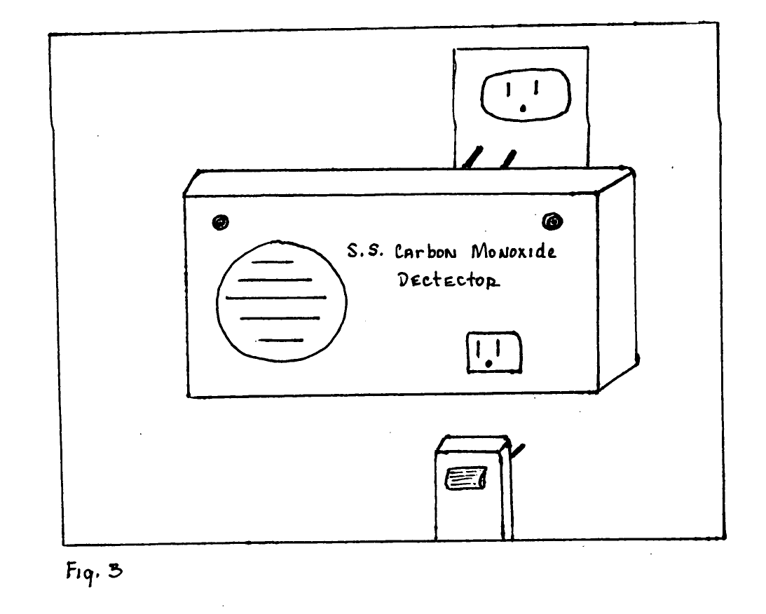

FIG. 3 reveals unit before it is plugged into the outlet and the outlet on the unit ready to receive garage door opener.

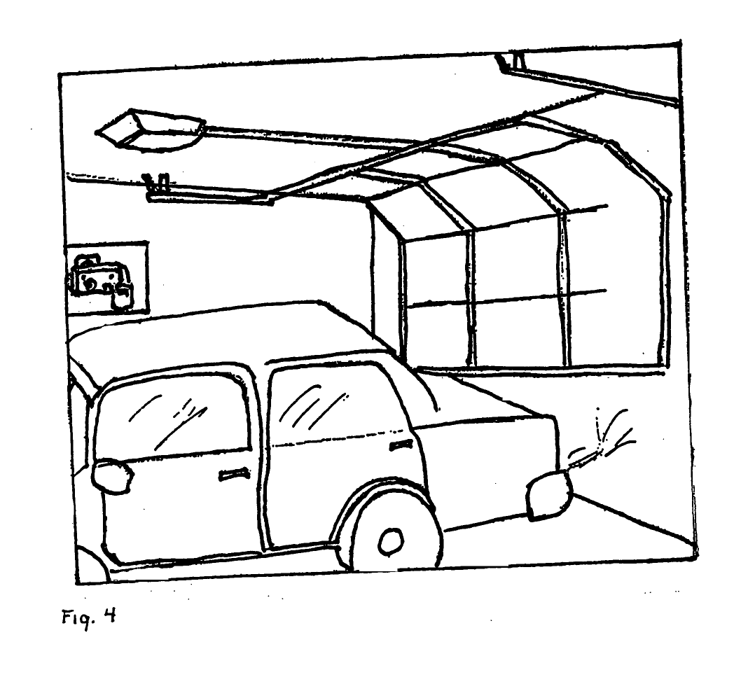

FIG. 4 demonstrates unit on the wall in operation after it has detected carbon monoxide fumes in a garage triggering the garage door to open to allow fumes to escape.

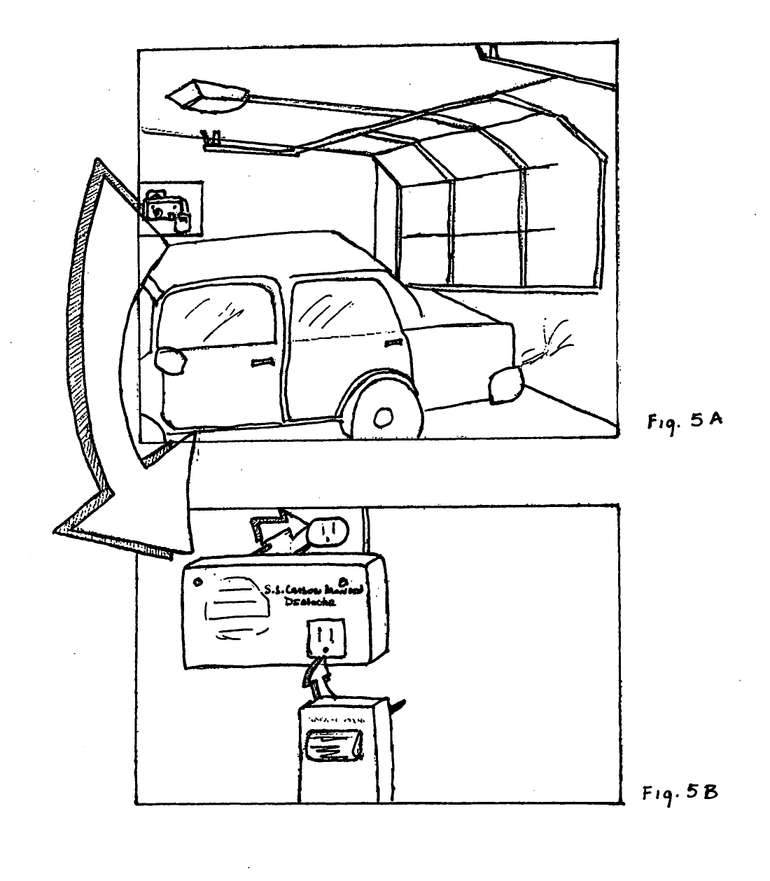

FIG. 5A shows unit in operation on wall of garage during detection of carbon monoxide fumes. FIG. 5B is a blowup of unit on the wall of garage and how it is installed.

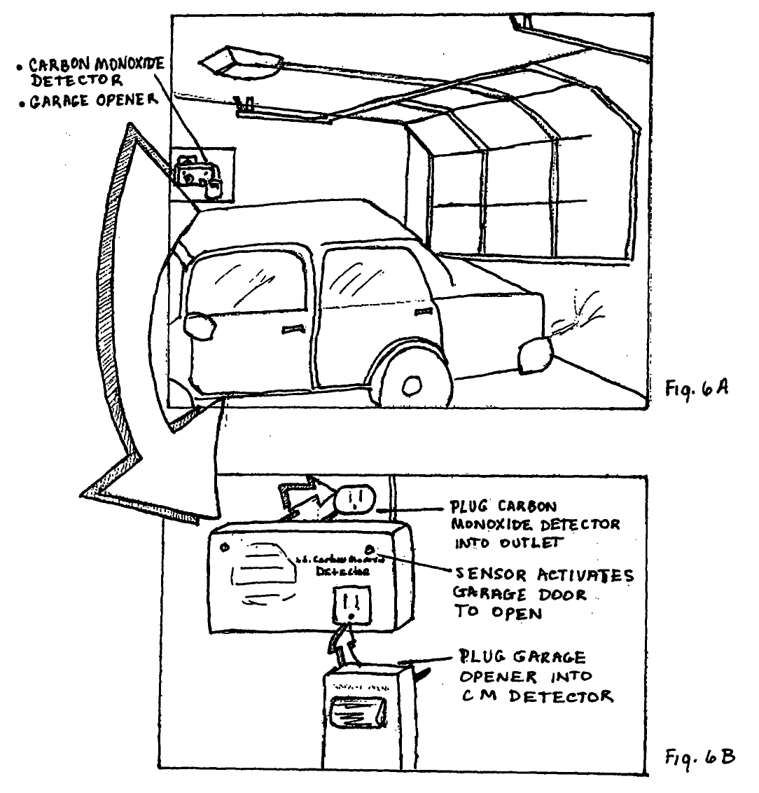

FIG. 6A Unit is in operation showing the location of unit in relation to garage door opener. FIG. 6B points the components in operation.

1. This device will activate a garage door to open automatically, when carbon monoxide buildup has been detected by this device. This will allow the carbon monoxide to be released from the enclosed area before it can harm or kill anyone inside the garage.
